(19) United States
(12) Patent Application Publication
(10) Pub. No.: US 2012/0311416 A1
(43) Pub. Date: Dec. 6, 2012

(54) INTEGRATED HAZARD MAPPING SYSTEM

(76) Inventors: Hannes Richter, Laguna Beach, CA (US); Kevin Trigg, San Clemente, CA (US)

(21) Appl. No.: 13/486,991

(22) Filed: Jun. 1, 2012

Related U.S. Application Data
(60) Provisional application No. 61/493,077, filed on Jun. 3, 2011.

(51) Int. Cl. G09G 5/00; G09G 5/02; G06F 17/00

(52) U.S. Cl. 715/202; 345/634; 715/234; 345/593; 345/636

(57) ABSTRACT

Systems, methods, and apparatus are disclosed for providing natural hazard information associated with a piece of property. In one aspect, a method is provided for providing natural hazard data. The method includes receiving geographic location information associated with a property. The method further includes retrieving natural hazard information associated with the geographic location of the property. The method further includes generating data based on the natural hazard information associated with the geographic location of the property for displaying on a computing device. The method further includes transferring the generated data to the computing device. Other aspects, embodiments, and features are also claimed and described.

### CROSS REFERENCE TO RELATED APPLICATIONS

This application claims benefit under 35 U.S.C. §119(e) to U.S. Provisional Patent Application No. 61/493,077 entitled “INTEGRATED HAZARD MAPPING SYSTEM” filed on Jun. 3, 2011, the disclosure of which is hereby incorporated by reference in its entirety.

### BACKGROUND

1. Field

The present application relates generally to providing a system for delivering natural hazard data.

2. Background

Natural hazards can include a variety of conditions that present risks or potential dangers to life, structures, or property. Common natural hazards include earthquakes, faults, landslides, debris flows, ground failure, expansive soil, floods, tsunamis, wildland fires, dam inundation, and the like. Furthermore, the risk of natural hazards may increase due to human activity such as improper grading, irresponsible irrigation, poor engineering, improper landscaping, or a failure to recognize the impact of activities on the surrounding terrain. Published information about natural hazards for an area is useful for analyzing potential risks to be used for future planning, valuation, and for taking precautionary measures.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One embodiment is a method for providing natural hazard data. The method includes receiving geographic location information associated with a property. The method further includes retrieving natural hazard information associated with the geographic location of the property. The method further includes generating data based on the natural hazard information associated with the geographic location of the property for displaying on a computing device. The method further includes transmitting the generated data to the computing device.

Another embodiment is an apparatus for providing natural hazard data. The apparatus includes a receiver configured to receive geographic location information associated with a property. The apparatus further includes a natural hazard information module configured to retrieve natural hazard information associated with the geographic location of the property. The apparatus further includes a processor configured to generate data based on the natural hazard information associated with the geographic location of the property for displaying on a computing device. The apparatus further includes a transmitter configured to transmit the data to the computing device.

Yet another aspect is an apparatus for providing natural hazard data. The apparatus includes means for receiving geographic location information associated with a property. The apparatus further includes means for retrieving natural hazard information associated with the geographic location of the property. The apparatus further includes means for generating data based on the natural hazard information associated with the geographic location of the property for displaying on a computing device. The apparatus further includes manes for transmitting the generated data to the computing device.

Still another aspect is an apparatus for providing natural hazard data. The apparatus includes a receiver configured to receive geographic location information associated with a property. The apparatus further includes an image processing module configured to generate a map image including natural hazard information and road and topographic map information for an area that includes the property based on the geographic location information. The image map is configured for display on a computing device.

### BRIEF DESCRIPTION OF THE DRAWINGS

FIG. 1 is a functional block diagram of an exemplary computer system for providing natural hazard information.

FIG. 2 is a functional block diagram of a computing device shown in FIG. 1 that may be used to request and display a report including natural hazard information for a property.

FIG. 3 is a flow chart of an implementation of an exemplary method for providing natural hazard data.

FIGS. 4A, 4B, and 4C are examples of natural hazard map data and road map data that may be combined to form a composite map image showing natural hazard information for a piece of property.

FIG. 5 shows an exemplary user interface for displaying a natural hazard information report.

FIG. 6 shows an example of a map image including natural hazard information including fault conditions for an area including a selected piece of property.

FIG. 7 shows an example of a map image including natural hazard information including potential flooding areas for an area including a selected piece of property.

FIG. 8 shows an example of a map image including natural hazard information about tsunami inundation zones for an area including a selected piece of property.

FIG. 9 shows an example of a map image including natural hazard information about soil slip conditions for an area including a selected piece of property.

FIG. 10 shows an example of a map image including natural hazard information about wildland fire hazard zones for an area including a selected piece of property.

FIG. 11 is a flowchart of an exemplary method for requesting and displaying natural hazard information for a piece of property.

FIG. 12 is a functional block diagram of an apparatus for requesting and displaying natural hazard information for a piece of property.

FIG. 13 is a flowchart of an exemplary method for providing natural hazard information.

FIG. 14 is a functional diagram of an apparatus for providing natural hazard information.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of implementations within the scope of the appended claims are described below. It should be apparent that the aspects described herein may be implemented in a wide variety of forms and that any specific structure and/or function described herein is merely illustrative. Based on the present disclosure a person/one having ordinary skill in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

Natural hazard information associated with a specific property or structure may be valuable for assessing future risks, for planning, for valuation, and the like. For example, real estate companies, potential home buyers, banking professionals, consultants, insurance companies, or government agencies, may wish to have access to natural hazard information (e.g. geologic hazard information) associated with a specific piece of property. However, information about natural hazards associated with a specific piece of property may be difficult to obtain or understand. In some cases, natural hazard maps may be compiled and provided by local, state, and federal governments for various areas. While these maps may provide natural hazard information for a determined area, it may be difficult to determine the exact location of a specific piece of property or structure on the hazard map. Furthermore, these maps may be difficult for laypersons to understand because the hazard map may include complex hazard information that is not suited for an untrained reviewer. As a result, those people making decisions with respect to a piece of property are often unaware of the impact of potential natural hazards on the property. Moreover, it can be a challenge for a layperson to readily understand the existing information because of its complexity.

Accordingly, in one aspect, a system is provided to deliver published natural hazard information associated with a specific property or structure in a way that is easy to interpret and understand. The system may include explanatory information to help explain or use the information and to help the user with any required further analysis of the natural hazards. The system may integrate existing natural hazard map data with other types of map data and information to provide natural hazard information for a specific address or piece of property upon request from a user.

As one example, a homebuyer may access a website that is hosted by a natural hazard information system as described herein. The user may input the desired address of the home and then be presented with one or more hazard maps that easily identify all of the geologic and other natural risks associated with that home. In one embodiment, the different geographic risks are color coded, such that risks of flood, tsunamis, wildland fire, dam inundation, soil slips, and earthquake hazards are each coded with a different color.

Another embodiment is a system that receives geologic map information from a map source, and then converts and provides that data is an easily acceptable format to a user. As one example, the system may input digital map data from a source, such as the California Department of Conservation, which provides the California Geological Survey information. That data may not be in a format that is easily displayed to a user on a webpage. Accordingly, the system may either preprocess, or in real-time, convert the data into a format, such as the Portable Document Format (PDF) which can be displayed to a web site user.

### DEFINITIONS

As used herein, an “input device” can be, for example, a keyboard, rollerball, mouse, voice recognition system or other device capable of transmitting information from a user to a computer. The input device can also be a touch screen associated with the display, in which case the user responds to prompts on the display by touching the screen. The user may enter textual information through the input device such as the keyboard or the touch-screen.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices.

As used herein, “instructions” refer to computer-implemented steps for processing information in the system. Instructions can be implemented in software, firmware or hardware and include any type of programmed step undertaken by components of the system.

A “microprocessor” or “processor” may be any conventional general purpose single- or multi-core microprocessor such as a Pentium® processor, Intel® Core™ a 8051 processor, a MIPS® processor, or an ALPHA® processor. In addition, the microprocessor may be any conventional special purpose microprocessor such as a digital signal processor or a graphics processor.

The system is comprised of various modules as discussed in detail below. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as SNOW LEOPARD®, iOS®, LINUX, UNIX or MICROSOFT WINDOWS®.

The system may be written in any conventional programming language such as C, C++, BASIC, Pascal, or Java, and run under a conventional operating system.

A web browser comprising a web browser user interface may be used to display information (such as textual and graphical information) to a user. The web browser may comprise any type of visual display capable of displaying information received via a network. Examples of web browsers include Microsoft's Internet Explorer browser, Mozilla's Firefox browser, Apple Safari and PalmSource's Web Browser, Google's Chrome browser, or any other browsing or other application software capable of communicating with a network.

The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

In addition, the modules or instructions may be stored onto one or more programmable storage devices, such as FLASH drives, CD-ROMs, hard disks, and DVDs. One embodiment includes a programmable storage device having instructions stored thereon that when executed perform the methods described herein.

### System Description

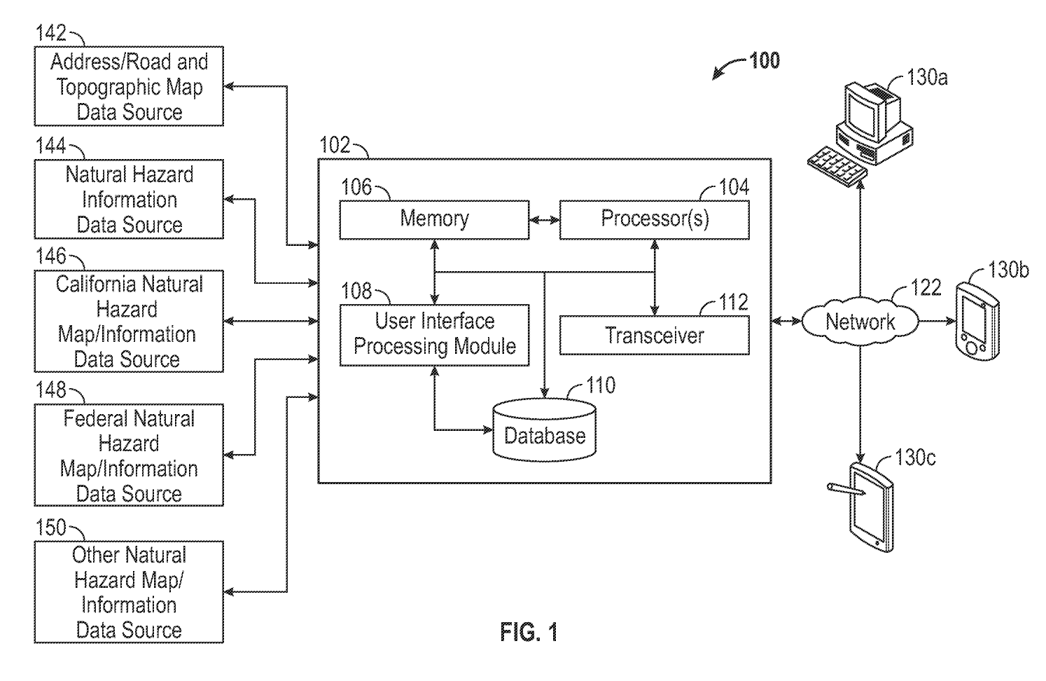

FIG. 1 shows an exemplary functional block diagram of a computer system 100 for providing natural hazard information. The computer system 100 may include a server computing device 102 including one or more processors 104, a memory 106, a user interface processing module 108, and a database 110. The server computing device 102 may further include a transceiver 112 that transmits and receives data via a network 122. A means for transmitting may include the transceiver 112. Likewise, a means for receiving may include the transceiver 112. The server computing device 102 may receive requests over a network 122 via the transceiver 112 for natural hazard information for a specific address or geographic location from a computing device 130a, 130b, or 130c operated by a user using an input device as will be further described below. A computing device 130a, 130b, or 130c may include a desktop computer, a laptop, a tablet computer, a smart-phone, or the like. The network 122 may be the Internet or any other fixed or mobile communications system. Once the server computer device 102 receives a request, the server computer device 102 may generate a report that provides natural hazard information based on the address or location provided as will be further described below for display on the computing device 130a, 130b, or 130c.

The server computer device 102 may generate the report in part by compiling and integrating information from a variety of different sources based on an address or location provided. To determine and provide location information for an address, the server computer device 102 may access an address/road and topographic map data source 142. This data may be used to for generating a map to display the location requested along with natural hazard information, as well as for use in determining the particular natural hazard map data associated with the address or location. The server computer device 102 may also access any one of several data sources that provide natural hazard data. For example, the server computer device 102 may access a natural hazard information data source 144 that provides general descriptions and explanations about different natural hazards and the risks they present to a location or address. The server computer device 102 may use this information for generating textual or visual explanations and descriptions of the integrated natural hazard map data. The server computer device 102 may also access existing natural hazard map data repositories and associated information provided by state and federal governments, such as accessing a state natural hazard map/information data source 146 and/or a federal natural hazard map/information data source 148. Furthermore, the server computer device 102 may further access other natural hazard map/information data sources 150 that may be provided by third parties or obtained from other sources.

The data sources 142, 144, 146, 148, and 150 may be accessed over a network (not shown) or may be stored in databases (not shown) accessible locally to or as part of the server computing device 102. For example, in one embodiment, the information in data sources 142, 144, 146, 148, and 150 may be stored in a database 110. In another embodiment, the information in the data sources 142, 144, 146, 148, and 150 may be stored in remote databases (not shown) and be accessed via a network (not shown). In one embodiment, when the server computing device 102 receives an address or location, the server computing device 102 may send a query to the applicable data sources 142, 144, 146, 148, and 150 to request and receive the required information. Furthermore, in other embodiments, the data sources 142, 144, 146, 148, and 150 may be accessed prior to any request for information sent to the server computer device 102. The server computing device 102 may then partially compile/integrate the information retrieved for later use in generating reports. Information retrieved from the data sources 142, 144, 146, 148, and 150 may be stored in the memory 106 and accessed by the processor(s) 102 and/or the user interface processing module 108.

Once information for an address or location is retrieved from the data sources 142, 144, 146, 148, and 150, the server computing device 102 may execute instructions to generate a report that is provided to and displayed on a computing device 130a, 130b, or 130c. A means for retrieving natural hazard information from the data sources 142, 144, 146, 148, and 150 may include the processor 104. Accordingly, the processor(s) 102 and/or user interface processing module 106 compiles and integrates the information from each of the data sources 142, 144, 146, 148, and 150 to generate a report. A means for generating data based on natural hazard information may include a user processing module and/or the processor 104.

Once a report has been generated, the server computer device 102 may deliver the natural hazard information over the network 122 to a computing device 130a, 130b, or 130c that originally requested the information. The computing device 130a, 130b, or 130c may then display the report including the natural hazard information for a user. The computing device 130a, 130b, and 130c are referred hereinafter collectively as a computing device 130.

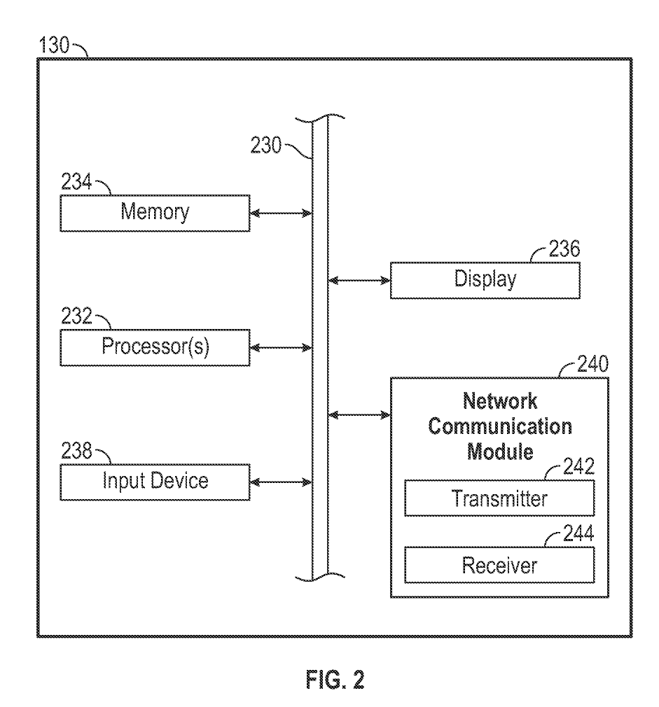

FIG. 2 is a functional block diagram of a computing device 130 shown in FIG. 1 that may be used to request and display a report including natural hazard information for a property. The computing device 130 generally includes a central data bus 230 linking several circuits together. The circuits include a processor 232 and a memory 234 similarly as described above with respect to the server computing device 102 shown in FIG. 1. The computing device 130 may include an input device 238 that may capture user input, for example, such as geographic location information regarding a piece of property. The data from the input device 238 may be provided to the processor 232. The processor 232 may use the user input to form a request for natural hazard information based on the geographic location information. The computing device 130 may further include a network communication module 240 that may be configured to send and receive information via a fixed or wireless network. The network communication module 240 may include a transmitter 242 for transmitting data via a communications network and a receiver 244 for receiving data via the communications network. The network communication module 240 may receive the request from the processor 232 and transmit the request to, for example, a server computing device 102 as described above with reference to FIG. 1. The network communication module 240 may further be configured to receive a report or other generated data with natural hazard information from the server computing device 102. The computing device 102 may further include a display 236 for displaying the report including natural hazard information. A means for displaying the report may include the display 236. The generated information received via the network communication module 240 may be provided to the processor for preparing the natural hazard information for displaying on the display 236.

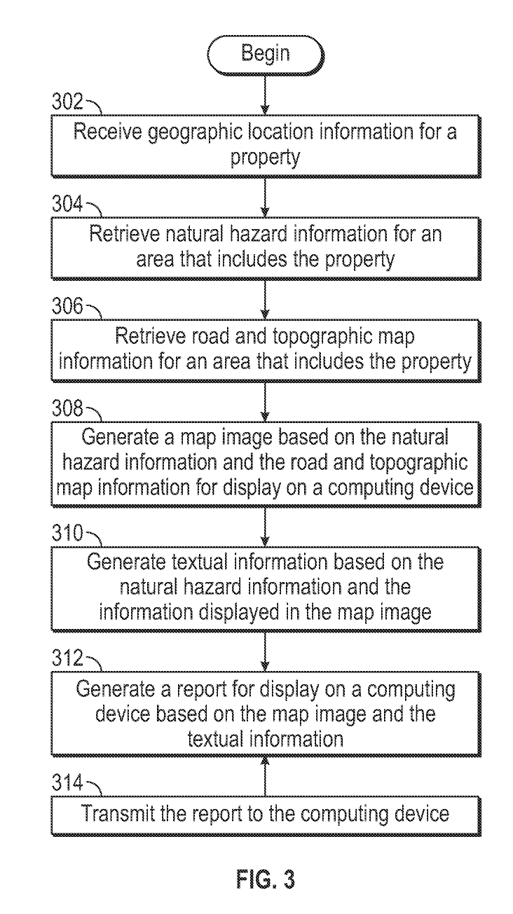

FIG. 3 is a flow chart of an implementation of an exemplary method 300 for providing natural hazard data. The method 300 may be performed, for example, by a server computing device 102 as shown in FIG. 1. Although the method 300 is described below with respect to elements of the server computing device 102, those having ordinary skill in the art will appreciate that other components may be used to implement one or more of the blocks described herein.

At block 302, geographic location information for a property is received. In one aspect, the geographic location information may be received by the server computing device 102. In one aspect, the geographic location information may be a street address of a piece of real property or structure. In another aspect, the geographic location information might be coordinates describing latitude and longitude data. At block 304, natural hazard information for an area that includes the property may be retrieved. In one aspect, as described above, the server computer device 102 may retrieve the information from one or more data sources such as the data sources 142, 144, 146, 148, and/or 150. For example, the data may be retrieved from the data sources 142, 144, 146, 148, and 150 via a network. In another aspect, information from the data sources 142, 144, 146, 148 and/or 150 may be retrieved at some other point in time and stored in a database 110 for retrieval by the server computing device 102. In some embodiments, at block 306, road and topographic map information for an area that includes the property may further be retrieved. For example, the server computing device 102 may retrieve the road and topographic map information from a road and topographic map data source 142. As described above, the data may be retrieved and stored in a database 110 of the server computing device 102 or the server computing device 102 may retrieve the road and topographic map information on an as needed basis by requesting the data via a network from the road and topographic map data source 142.

At block 308, a map image based on the natural hazard information and the road and topographic map information may be generated for display on a computing device 130. In one aspect, the user interface processing module 108 of the server computing device 102 uses the natural hazard information and the road and topographic map information to create a map image. The user interface processing module 108 may overlay natural hazard map information on road and topographic map information to create a composite map showing both the natural hazard information and road and topographic map information. Furthermore, the user interface processing module 108 may generate a graphic indicator that indicates the location of the property on the map image. The natural hazard information and road and topographic map information may be in a variety of formats that may or may not be compatible with the form generation process. For example, the natural hazard data may be in the form of a PDF file, image files (of various formats), text files, and the like. The natural hazard information may therefore be in a format that is difficult for a user to interpret and/or is initially incompatible for ready combination for display in a report that is easily understandable to the user. Thus, in one embodiment, filters or conversion routines of the user interface processing module 108 may be used to convert the data source information into usable map information. Conversion routines and filters may be further used to convert the data into a format that may be conveniently displayed on the display 236 (e.g., within a web browser) and which provides the user with a report that is easy to understand.

For example, if the map data is in a digital image format, such as a Portable Document Format (PDF), then it may need to be digitally processed to break the map into the appropriate format for presentation to the user of the system. Processing can occur, for example by using Photoshop™ or similar imaging software and other image processing modules to extract/duplicate relevant data layers from the PDF file, creating a layer which preserves the location (latitude and longitude) of the data. This layer can be stored as a Portable Network Graphics (PNG) file or similar image format in a program database 110 for use as a natural hazard overlay.

Furthermore, the map data may be stored as an image file where one image file may include information regarding natural hazards while a separate image file may include road and topographic map information. In this case, the separate image files may be processed in a variety of ways to be able to overlay one image on another to create a final image data for display. For example, routines and filters may be provided in the user interface processing module 108 to remove certain information from an image file, convert certain pixel information into transparent image data, darken or lighten certain portions of an image file, alter other pixel information, and the like. In addition, the map data may be stored in an image file that includes natural hazard or road and topographic map data for a large geographic area. In some cases it may be useful to use and display a much smaller portion of the image file that includes an area including the location of the piece of property at interest. Routines may therefore be provided by the user interface processing module 108 to crop or otherwise identify a smaller area of the image file for processing that includes the location of the piece of property at interest.

Furthermore, a variety of formats may be used to provide a report to be displayed on a computing device 130. For example, the map image may be generated for display directly within a browser. As such, conversion routines may be provided to convert the files of different formats into a single image that is of a type that may be displayed within a browser. Furthermore, the routines may be configured to automatically generate HTML or other hypertext to provide code for displaying the image within a report with other information. In another embodiment, as stated above, the user interface processing module 108 may combine data from different sources to create a document such as a PDF that may be displayed in the browser or retrieved and displayed at a later time.

In addition, at least some of the map information may be in the form of text which may be difficult to interpret by a user. In some embodiments, conversion routines may be provided to convert the textual information into graphical information that may be stored in an image file or PDF file and displayed as part of a report. For example, certain structures or other geographic features may be stored as geographic coordinates. Graphical indicators may be generated by the user interface processing module 108 based on the coordinates for display to the user.

At block 310, textual information based on the natural hazard information and the information displayed in the map image may be generated for display on a computing device. The user interface processing module 108 may further be used to generate the textual information. In one aspect, the textual information may be displayed alongside the map image and provide explanations of the natural hazard information shown in the map, for example, such as risk levels and other interpretative materials. The user interface processing module 108 may include an extraction process that removes and reformats explanatory data that may accompany the map data in order to present it conveniently to the users on a display device 130 based on the particular natural hazard information retrieved for the area including a selected property.

As such, at blocks 308 and 310, the user interface processing module 108 may combine map data from the data sources 142, 144, 146, 148, and 150 to generate a composite map that shows both address/road and topographic data along with natural hazard data along with explanatory text. At block 312, a report for display on the computing device 130 may be generated based on the map image and the textual information. The user interface processing module 108 generates the report in one aspect by formatting the map image and the text for display on the computing device 130. In some cases, there may be different natural hazard maps associated with different types of natural hazards. For example, natural hazard information may be provided for different natural hazards such as seismic landslide and liquefaction, soil slip susceptibility, fault zones, flood hazard areas, tsunami inundation, wildland fire, dam inundation, and the like. As such, a composite map may be generated for each type of hazard for which map data is available along with explanatory text or other related information. Each composite map and explanation may be provided as one report or as several different reports to be provided to a computing device 130. At block 314, the report may be transmitted to the computing device, for example via the network 122.

In some embodiments, the report generates additional information that may be used for real estate transactions, or for other types of uses. For example, based on the location information provided for a piece of property, a state natural hazards disclosure statement may be generated for printing via the computing device 130. The statement may be used to provide valid natural hazard information for subsequent real estate transactions. The report may therefore be formatted into a standardized format with information provided that is based on the geographic location of a piece of property of interest. The report may indicate whether a piece of property is in one of the following: a flood zone (based on either 100 year flood data or potential dam inundation), fire zone, earthquake fault zone, or areas with possible liquefaction or landslide hazards.

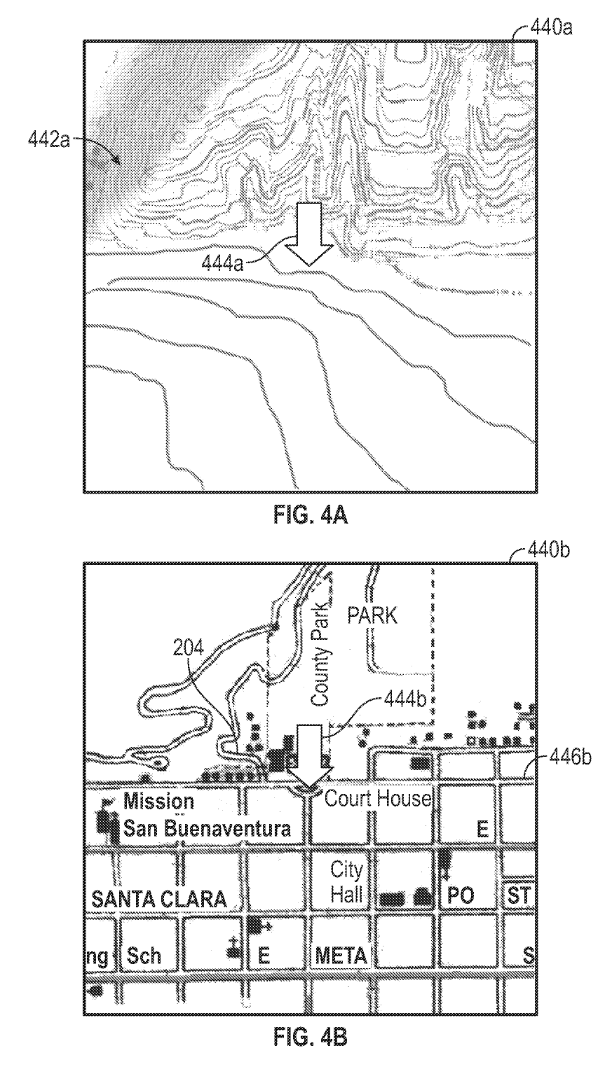

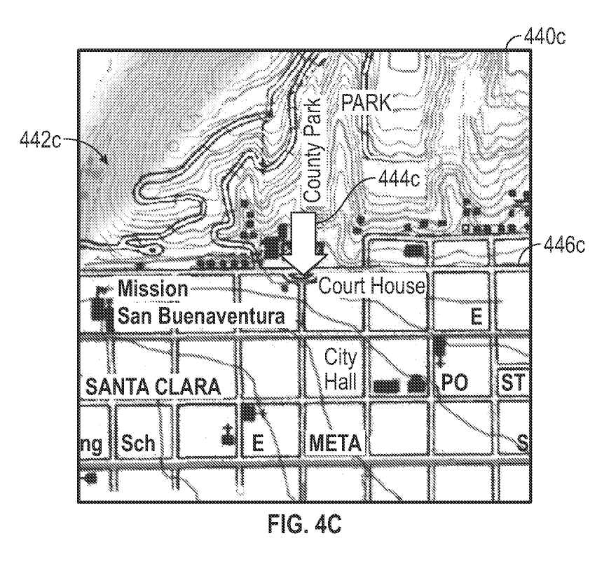

FIGS. 4A, 4B, and 4C are examples of natural hazard map data and road and topographic map data that may be combined to form a composite map image showing natural hazard information for a piece of property. FIGS. 4A, 4B, and 4C are provided to show an example of how a map image may be generated as described with reference to block 308 of FIG. 3. For example, FIG. 4A shows natural hazard map data 440a for an area that includes a selected piece of property. The property is indicated by the arrow 444a. The natural hazard map data includes natural hazard information 442a in the form of a shaded region that may correspond to, for example, and area of increased risk for landslides, along with other geologic information such as topographical contour lines. FIG. 4B shows road map data 440b for an area that includes the selected piece of property as indicated by the arrow 444b. As shown, the road map data 440b may include road map information 446b showing roads, buildings, prominent landmarks, property lines, and the like. In some embodiments, the road map data 440b may include topographic data. Thus, the natural hazard map data 440a shown in FIG. 4A may not include the topographic content that is instead included in the road map data 440b and may only include the natural hazard data. The natural hazard map data 440a of FIG. 4A and the road map data 440b of FIG. 4B may be processed such that one may overlay one map on top of the other to form a composite map. For example, the user interface processing module 108 may be configured to process the images to create transparent regions or perform other image processing functions to overlay the natural hazard map data 440a on the road map data 440b to create a composite map as shown in FIG. 4C. FIG. 4C shows a map image 440c with a graphic indicator 444c showing the location of the property along with road and topographic map information 446 and natural hazard information 442c. In this way a user may be able to see location information regarding a specific piece of property in the context of other roads/buildings along with natural hazard information. As described above, a variety of different conversion routines and filters may be provided by the user interface processing module 108 to generate the map image 440c.

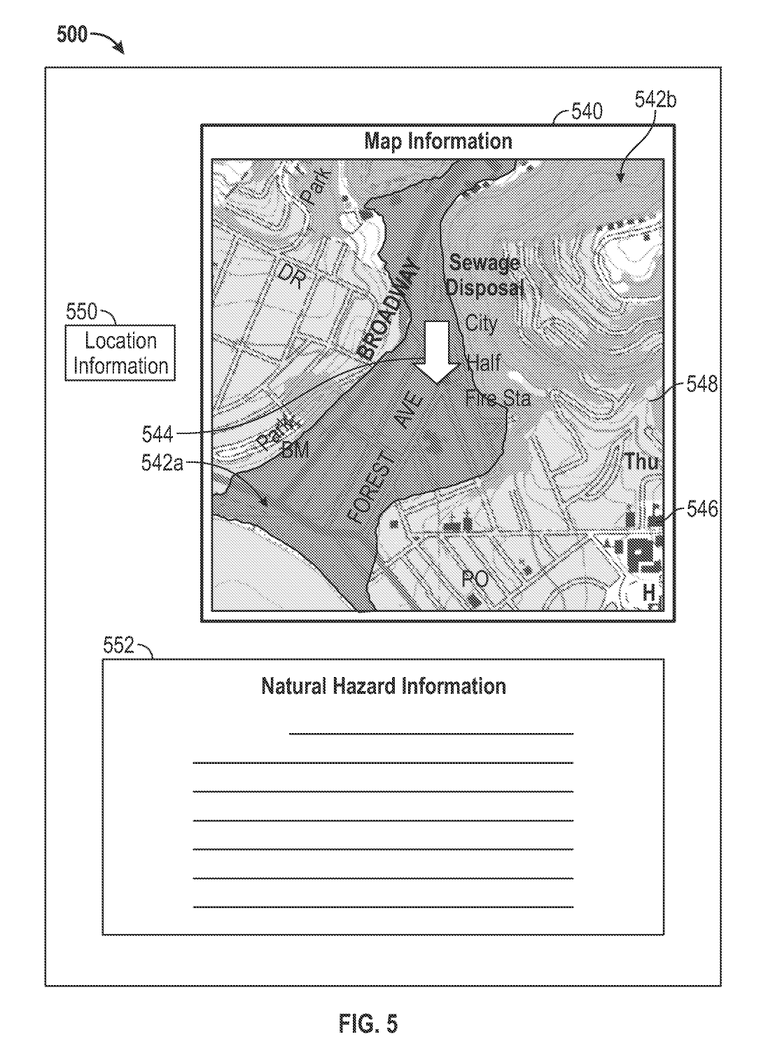

FIG. 5 shows an exemplary user interface 500 for displaying a natural hazard information report that may be provided to a computing devices 130 as described above. The report may be generated by a server computing device 102 as described above with reference to blocks 308-312 of FIG. 3. The user interface 500 may display location information 550 identifying a current address or other location identification based on which the report has been generated. The user interface 500 may further provide a map image 540 to visually show the natural hazard risks and information for the location being analyzed. For example, as described above, a composite map may be displayed showing address/road specific information as indicated by 546 overlaid with natural hazard information as shown by 542a and 542b. For example, the shaded region indicated by 542a may identify a region identified with a risk of liquefaction during an earthquake. Further, a lighter shaded region indicated by 542b may identify a region susceptible to earth-quake induced landslides. The shaded regions 542a and 542b may be different colors, and may further be configured to display street/road map information within the shaded regions 542a and 542b. Accordingly, the map may incorporate a variety of indicators and shaded or colored regions to provide information about specific natural hazards. In this way, the user may use the map to associate natural hazard information with a specific location or address. In order to provide further explanation and or analysis of the map information 504, the user interface 500 further displays other additional natural hazard information 552. In addition, the user interface 500 may include a graphic indicator 544 that may show the location of a selected piece of property within the map image 540. The user interface 500 may further provide additional geologic information 548 such as topographical contours or other types of geologic information that may be included.

As stated, the user interface 500 may include additional text or graphics used to explain features of the map information 540 and to provide further details about the risks presented by natural hazards for that location. For example, the additional natural hazard information 552 may provide descriptions of the source of the natural hazard map data, the level of risk to the property based on the compiled information, descriptions of the various types of risks determined by the natural hazard, and the like. Where maps for different types of natural hazards for a location have been generated and provided by the server computing device 102, the user interface 500 may provide a different display or page for each of the different maps along with any accompanying information. The user interface 500 may further display links or information that allows a user to be connected with further information about the natural hazard data presented.

As stated, it should be appreciated that a variety of different natural hazard information may be displayed either along or in combination. This information may include information about seismic landslide and liquefaction, soil slip susceptibility, fault zones, flood hazard areas, tsunami inundation, wildland fire, dam inundation, and the like.

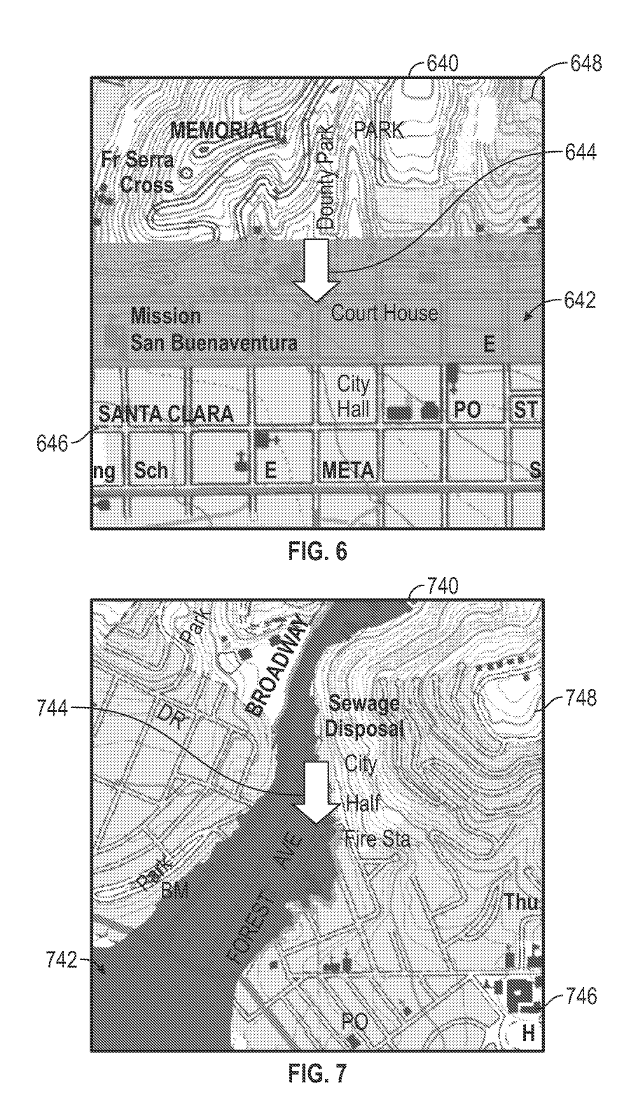

FIG. 6 shows an example of a map image 640 including natural hazard information including fault conditions for an area including a selected piece of property. The map image includes geologic information 648 such as topographic contours as well as road and topographic map information 646 including roads and other buildings. An indicator 644 is shown to indicate a location of a selected property location. Furthermore, a shaded region 642 may be provided to show any area of active faulting. For example, the shaded region 642 may correspond to a zone including a fault where there may be regulatory limits on the type of construction allowed or other structural requirements. Moreover, information regarding risks of damage due to an earthquake in the shaded region 642 may be provided. The road and topographic map information allows a user to be able to view the different buildings and property that may be impacted by natural hazards such as the fault zone 642. The map image 640 may be incorporated into a user interface as described above with reference to FIG. 5.

FIG. 7 shows an example of a map image 740 including natural hazard information including potential flooding areas for an area including a selected piece of property. As with the map images described above, the map image 740 includes geologic information 748 such as topographic contours, road and topographic map information 746, and an indicator 744 of a piece of property. In this case, the map image 740 includes a shaded region 742 that shows a flood hazard area to show zones of increased flood risk. For example, the darker shaded region 742 may correspond to an area where there may be a 1% annual chance of flooding for a 100-year flood levels. As shown, the map image 740 may indicate that a selected piece of property is located within an area of increased flood risk. This may allow a user to better understand property needs for flood insurance or to plan development and construction to account for increased flood risks. The map image 740 may be incorporated into a user interface as described above with reference to FIG. 5. In some embodiments, a map image (not shown), similar to the map image 740 of FIG. 7, may be generated to show areas that may be flooded due to dam inundation.

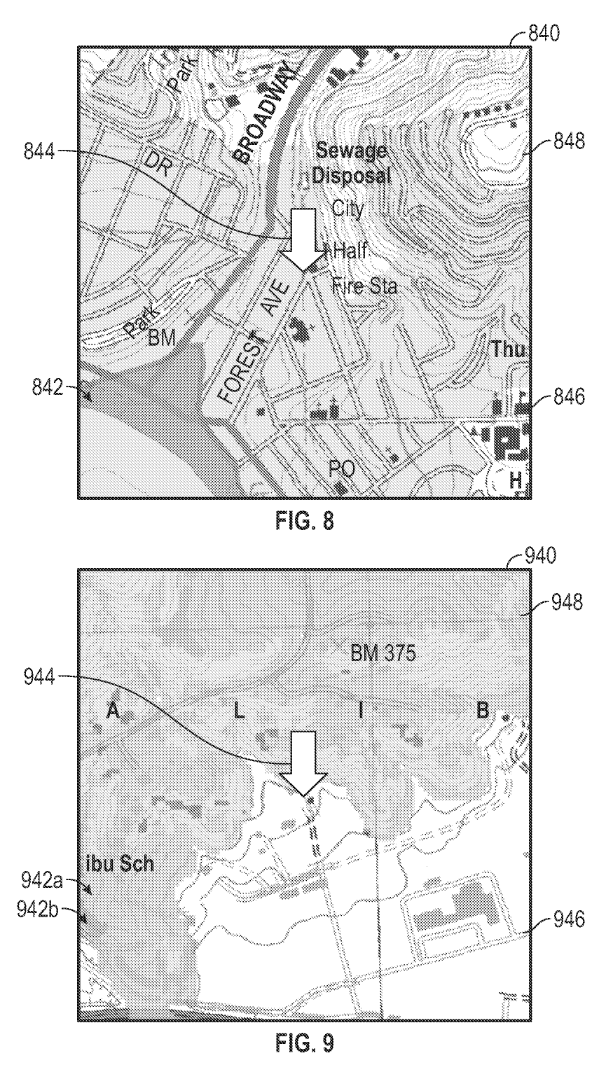

FIG. 8 shows an example of a map image 840 including natural hazard information about tsunami inundation zones for an area including a selected piece of property. Similarly as described above, the map image 840 includes geologic information 848 such as topographic contours, road and topographic map information 846, and an indicator 844 of a piece of property of interest to a user. The map image 840 further includes a shaded region 842 indicating a likely area for tsunami inundation. The map image 840 may be incorporated into a user interface as described above with reference to FIG. 5.

FIG. 9 shows an example of a map image 940 including natural hazard information about soil slip conditions for an area including a selected piece of property. Similarly as described above, the map image 940 includes geologic information 948 such as topographic contours, road and topographic map information 946, and an indicator 944 of a piece of property of interest to a user. The map image 940 further includes shaded regions 942a and 942b showing areas of increased risk for soil-slip. The shaded regions 942a and 942b may correspond to areas where soil-slip debris flows (i.e., mudslides) are more likely to happen due to high rainfall or other causes. In this case, the different shaded regions 942a and 942b may be shaded differently (e.g., using different colors) to show different degrees of risk. For example, the lighter shaded region 942a may be associated with an area of less risk as compared to the darker shaded regions 942b. The map image 940 may be incorporated into a user interface as described above with reference to FIG. 5.

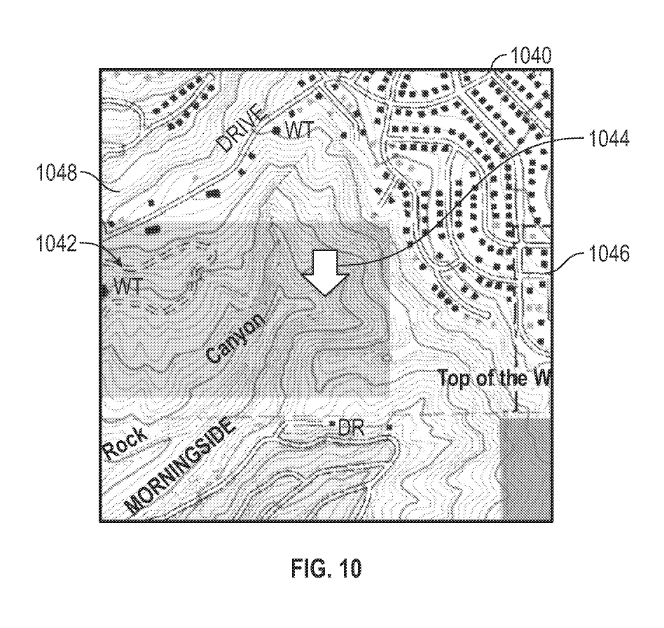

FIG. 10 shows an example of a map image 1040 including natural hazard information about wildland fire hazard zones for an area including a selected piece of property. The map image 1040 includes geologic information 1048 such as topographic information, road information 1046, and an indicator 1044 of a piece of property of interest to a user. The map image 1040 further includes a shaded region 1042 showing an area of increased risk for wildfires. While not shown, the map image 1040 could include different shaded regions of different shades or colors that may correspond to different wildland fire risk levels based on some objective criteria. The map image 1040 may be incorporated into a user interface as described above with reference to FIG. 5.

It should be appreciated that more than one type of natural hazard information may be combined and included on a single map. For example, a map image may show both flooding information and liquefaction information for an area including a selected piece of property. In one aspect, different colored shaded regions may correspond to different natural hazards.

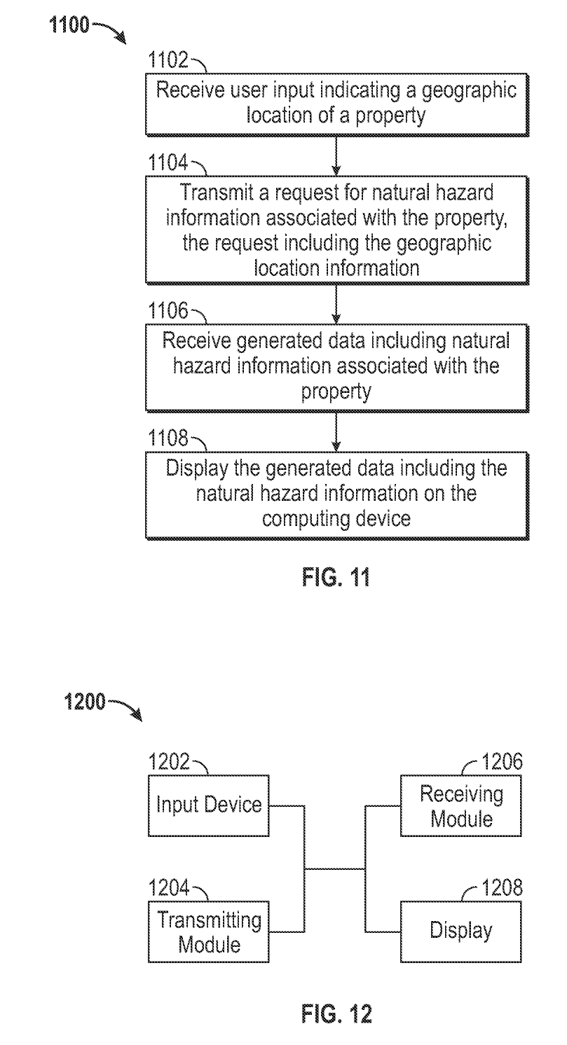

FIG. 11 is a flowchart of an exemplary method 1100 for requesting and displaying natural hazard information for a piece of property. Although the method 1100 is described below with respect to elements of the computing device 130 (FIG. 2), those having ordinary skill in the art will appreciate that other components may be used to implement one or more of the steps described herein.

At block 1102 user input indicating a geographic location of a property is received. The user input may be received by an input device 238. In one aspect, the geographic location may be a street address or longitude/latitude information. Using the received geographic location information, a request for natural hazard information associated with the property may be transmitted. In one aspect, a processor 232 may form the request using the geographic location information and transmit the request via a network communication module 240 to a server computing device 102. In response, at block 1106, generated data including natural hazard information associated with the property may be received. In one aspect, the network communication module 240 may receive the generated data. In one aspect, the generated data may be a report such as the report shown above in FIG. 5. At block 1108, the generated data including the natural hazard information may be displayed on the computing device 130. For example, the generated data may be provided the a processors 232 for processing and displaying via a display 236. In one aspect, the generated data may be displayed on the display 236 using a web browser.

FIG. 12 is a functional block diagram of an apparatus 1200 for requesting and displaying natural hazard information for a piece of property. Those skilled in the art will appreciate that the apparatus 1200 may have more components than the apparatus 1200 shown in FIG. 12. The apparatus 1200 shown includes only those components useful for describing some prominent features of certain embodiments. The apparatus 1200 includes an input device 1202 for receiving input from a user. In some cases, a means for receiving user input may include the input device 1202. The input device 1202 may be configured to perform one or more of the functions described above with respect to block 1202 of FIG. 12. The apparatus further includes a transmitting module 1204 for transmitting a request for natural hazard information. In some cases, a means for transmitting may include the transmitting module 1204. The transmitting module 1204 may be configured to perform one or more of the functions described above with respect to block 1204 of FIG. 12.

The apparatus further includes a receiving module 1206 for receiving generated data including natural hazard information. The receiving module 1206 may be configured to perform one or more of the functions described above with respect to block 1106 of FIG. 11. In some cases, the receiving module 1204 and transmitting module 1206 may share various components such as an antenna and/or operate as a transceiver. The apparatus further includes a display 1208 for displaying generated data including natural hazard information. The display 1208 may be configured to perform one or more of the functions described above with respect to block 1108 of FIG. 11.

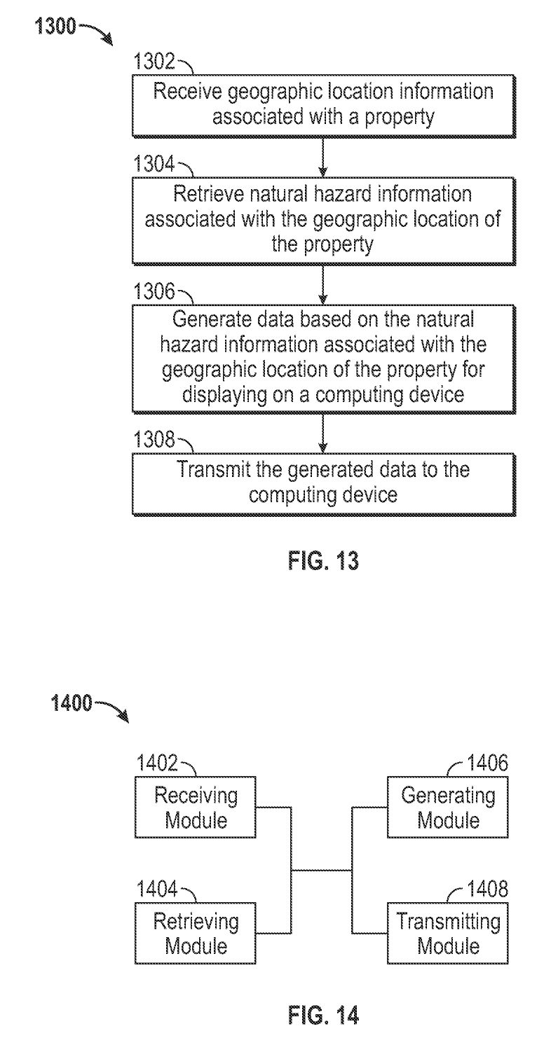

FIG. 13 is a flowchart of an exemplary method 1300 for providing natural hazard information. Although the method 1300 is described below with respect to elements of the server computing device 102 (FIG. 1), those having ordinary skill in the art will appreciate that other components may be used to implement one or more of the steps described herein.

At block 1302, geographic location information associated with a property is received. For example, the server computing device 102 may receive the information via a network 122. The geographic location information may include a street address or longitude/latitude information. At block 1304, natural hazard information associated with the geographic location of the property is retrieved. In one aspect, the server computing device 102 may retrieve the information stored in a database 110 or accessed via one or more external and/or internal data sources such as data sources 144, 146, 148, and 150. At block 1306, data based on the natural hazard information associated with the geographic location of the property is generated for displaying on a computing device 130. In one aspect, a user interface processing module 108 may generate the data. In one aspect, the data may include map images along with explanatory text as described above. At block 1308, the generated data is transmitted to the computing device 130. The server computing device 102 may transmit the generated data via a network 122 to the computing device 130 for display.

FIG. 14 is a functional diagram of an apparatus 1400 for providing natural hazard information. Those skilled in the art will appreciate that the apparatus 1400 may have more components than the apparatus 1400 shown in FIG. 14. The apparatus 1400 shown includes only those components useful for describing some prominent features of certain embodiments. The apparatus 1400 includes a receiving module 1402 for receiving geographic location information associated with a property. The receiving module 1402 may be configured to perform one or more of the functions described above with respect to block 1302 of FIG. 13. The apparatus further includes a retrieving module 1404 for retrieving natural hazard information associated with the geographic location of the property. The retrieving module 1404 may be configured to perform one or more of the functions described above with respect to block 1304 of FIG. 13.

The apparatus further includes a generating module 1406 for generating data based on the natural hazard information. The generating module 1406 may be configured to perform one or more of the functions described above with respect to block 1306 of FIG. 13. The apparatus further includes a transmitting module 1408 for transmitting the generated data to a computing device 130. The transmitting module 1408 may be configured to perform one or more of the functions described above with respect to block 1308 of FIG. 13.

A person/one having ordinary skill in the art would appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, that may be designed using source coding or some other technique), various forms of program or design code incorporating instructions (that may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-13 may be implemented within or performed by an integrated circuit (IC). The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

What is claimed is:

1. A method for providing natural hazard data, the method comprising:
receiving geographic location information associated with a property;
retrieving natural hazard information associated with the geographic location of the property;
generating data based on the natural hazard information associated with the geographic location of the property for displaying on a computing device; and
transmitting the generated data to the computing device.

2. The method of claim 1, wherein retrieving natural hazard information comprises retrieving natural hazard map data for an area that includes the property, and wherein generating the data comprises generating a map image for displaying on the computing device based on the digital natural hazard map data.

3. The method of claim 2, further comprising retrieving road and topographic map data associated with the geographic location of the property, and wherein generating the map image comprises generating the map image to include at least a portion of the road map data.

4. The method of claim 3, wherein the road and topographic map data is in a first data file format, wherein the road and topographic map data is in a second data file format, and wherein generating the map image comprises combining the natural hazard map data and the road and topographic map data to create the map image in a third data file format that is compatible for display in a web browser of the computing device, the third data file format being the same or different than the first data file format and the second data file format.

5. The method of claim 4, wherein generating the map image comprises converting the natural hazard map data and the road and topographic map data into a common file format.

6. The method of claim 3, wherein generating the map further comprises generating a graphic indicator that indicates a location of the property on the map image.

7. The method of claim 2, wherein generating the map image comprises generating one or more color shaded areas on the map image indicating at least a portion of the natural hazard information associated with the geographic location of the property.

8. The method of claim 2, wherein the natural hazard map data comprises a graphics data file, and wherein generating the map image comprises at least one of removing information from the graphics data file, cropping a portion of the graphics data file, altering one or more pixels of the graphics data file, and applying an image filter to the graphics data file.

9. The method of claim 2, wherein generating the map image comprises converting the natural hazard map data into a format for display in a web browser of the computing device, and wherein generating the data further comprises generating a data file that includes a HyperText Markup Language (HTML) file for displaying the map image and textual information in the web browser.

10. The method of claim 2, wherein generating the data comprises generating a portable document format (PDF) file that includes information to display the map image and textual information based on the natural hazard information.

11. The method of claim 1, wherein the natural hazard information comprises textual information, and wherein generating the data further comprises generating text for display based on the natural hazard information associated with the geographic location of the property.

12. The method of claim 1, wherein the natural hazard information comprises information regarding at least one of earthquakes, faults, landslides, liquefaction, debris flows, ground failure, expansive soil, floods, dam inundation, wildland fires, and tsunamis.

13. The method of claim 1, wherein the geographic location information comprises a street address of the property.

14. An apparatus for providing natural hazard data, the apparatus comprising:
a receiver configured to receive geographic location information associated with a property;
a natural hazard information module configured to retrieve natural hazard information associated with the geographic location of the property;
a processor configured to generate data based on the natural hazard information associated with the geographic location of the property for displaying on a computing device; and
a transmitter configured to transmit the data to the computing device.

15. The apparatus of claim 14, wherein the natural hazard information comprises natural hazard map data for an area that includes the property, and wherein the processor is configured to generate the data at least by generating a map image for displaying on the computing device based on the digital natural hazard map data.

16. The apparatus of claim 15, further comprises a road and topographic map data module configured to retrieve road and topographic map data associated with the geographic location of the property, and wherein the processor is configured to generate the map image to include at least a portion of the road and topographic map data.

17. The apparatus of claim 16, wherein the processor is further configured to generate the map image by generating a graphic indicator that indicates a location of the property on the map image.

18. The apparatus of claim 15, wherein the processor is further configured to generate the map image by generating one or more color shaded areas on the map image indicating at least a portion of the natural hazard information associated with the geographic location of the property.

19. The apparatus of claim 14, wherein the natural hazard information comprises textual information, and wherein the processor is configured to generate the data by at least generating text for display based on the natural hazard information associated with the geographic location of the property.

20. The apparatus of claim 14, wherein the natural hazard information comprises information regarding at least one of earthquakes, faults, landslides, liquefaction, debris flows, ground failure, expansive soil, floods, dam inundation, wildland fires, and tsunamis.

21. The apparatus of claim 14, further comprising a database for storing the natural hazard information.

22. An apparatus for providing natural hazard data, the method comprising:
means for receiving geographic location information associated with a property;
means for retrieving natural hazard information associated with the geographic location of the property;
means for generating data based on the natural hazard information associated with the geographic location of the property for displaying on a computing device; and
means for transmitting the generated data to the computing device.

23. An apparatus for providing natural hazard data, the apparatus comprising:
a receiver configured to receive geographic location information associated with a property; and
an image processing module configured to:
retrieve natural hazard information in a first data format for an area that includes the property based on the geographic location information;
retrieve road and topographic map information in a second data format for an area that includes the property based on the geographic location information; and
convert the natural hazard information and the road and topographic map information into a map image including at least a portion of the natural hazard information and the road and topographic map information for the area that includes the property based on the geographic location information, the map image being configured for display in a web browser on a computing device.

24. The apparatus of claim 23, further comprising a database configured to store the natural hazard information and the road and topographic map information.

25. The apparatus of claim 23, further comprising a controller configured to generate textual information based on the natural hazard information for displaying on the computing device with the map image.
